(19) United States
(12) Patent Application Publication
(10) Pub. No.: US 2022/0343750 A1
(43) Pub. Date: Oct. 27, 2022

(54) ALERTING SYSTEM

(71) Applicants: Lori WRIGHT, Wildwood Crest, NJ (US); David WRIGHT, Wildwood Crest, NJ (US)

(72) Inventors: Lori WRIGHT, Wildwood Crest, NJ (US); David WRIGHT, Wildwood Crest, NJ (US)

(21) Appl. No.: 17/727,116

(22) Filed: Apr. 22, 2022

Related U.S. Application Data
(60) Provisional application No. 63/178,828, filed on Apr. 23, 2021.

(51) Int. Cl. G08B 21/22; G08B 21/24; G08B 21/02; G08B 3/10; B60N 2/00; G01G 19/52

(52) U.S. Cl. CPC G08B 21/22; G08B 21/24; G08B 21/0205; G08B 21/0236; G08B 21/0269; G08B 3/10; B60N 2/002; G01G 19/52

(57) ABSTRACT

A cargo alerting system that is self-arming. Placing a child in a car seat having sensors arms the system. A keyfob, or smartphone, which is carried by the user, outputs an alarm when the keyfob is moved farther than a pre-determined distance from the base, which may be in the car seat, or otherwise connected to a child in the vehicle. This preset distance could be any desired distance. The keyfob and alarm refocus the user's attention on the cargo within the vehicle.

### CROSS REFERENCE TO RELATED APPLICATIONS

The present application claims the benefit of U.S. Provisional Patent Application No. 63/178,828 filed Apr. 23, 2021, entitled “Cargo Alerting System for a Vehicle”, the entire disclosure of which is hereby incorporated herein by reference.

### BACKGROUND

In the United States many young children are inadvertently left in cars, and other vehicles. The interior temperature of a car or other vehicle can reach dangerously high temperatures. In the U.S., children die in hot cars unnecessarily from heat exhaustion after being left in a closed vehicle.

Thus, there is a need for a cargo alerting system operable for alerting an individual who exits a vehicle that addresses the aforementioned tragic problems with conventional vehicular systems. Such a need is satisfied by the cargo alerting system provided in the subject disclosure.

### BRIEF SUMMARY OF THE DISCLOSURE

One embodiment of the disclosure is directed to an alert system comprising: a sensor configured to sense an initial weight, a second weight, and an initial distance of the sensor to a transceiver, and generate a sensor signal upon sensing a changed distance from the initial distance that exceeds a predetermined threshold when the second weight has been sensed; and wherein the transceiver, operatively coupled to the sensor, is configured to receive the sensor signal from the sensor and generate an alert signal based at least in part on the sensor signal.

Another embodiment is directed to the alert system described above, wherein the sensor is a moisture sensor.

Yet another embodiment is directed to the alert system described above, wherein the sensor is configured to sense a shift in a weight distribution.

Yet another embodiment is directed to the alert system described above, wherein the sensor is configured to transmit the sensor signal to emergency personnel.

Yet another embodiment is directed to the alert system described above, wherein the sensor is configured to transmit the sensor signal to a third party.

Yet another embodiment is directed to the alert system described above, wherein the transceiver is configured to output an audible alarm.

Yet another embodiment is directed to the alert system described above, wherein the sensor is configured to output an audible alarm.

Yet another embodiment is directed to the alert system described above, wherein the sensor signal includes location data of the sensor to one or more devices or locations.

Yet another embodiment is directed to a notification system comprising: a support seat; a sensor disposed in the support seat, the sensor configured to sense an increase in weight of the support seat, and an increase in a distance between the sensor and a transceiver, when there is an increase in weight, and generate a sensor signal when the increase in distance between the sensor and the transceiver exceeds a pre-determined distance; and the transceiver, operatively coupled to the sensor, the transceiver configured to receive the sensor signal from the sensor, and generate a notification based at least in part on the sensor signal.

Yet another embodiment is directed to the notification system described above, wherein the sensor is configured to generate an audible distress alarm based at least in part on the sensor signal.

Yet another embodiment is directed to the notification system described above, wherein the sensor is configured to transmit the notification to a remote device.

Yet another embodiment is directed to the notification system described above, wherein the remote device is associated with a preset mobile phone number.

Yet another embodiment is directed to the notification system described above, wherein the sensor is configured to transmit location data of the sensor to the transceiver and the sensor is configured to transmit location data of the sensor to a remote device.

Yet another embodiment is directed to the notification system described above, wherein the sensor is configured to sense a change in weight distribution and generate a sensor signal when a change in weight distribution is sensed.

Yet another embodiment is directed to the notification system described above, wherein the sensor is configured to: sense moisture on the support seat; and generate an alarm based at least in part on the sensed moisture.

Yet another embodiment is directed to a method for providing an alert comprising: identifying an initial weight; identifying additional weight; setting a sensor setting to reflect the additional weight; sensing an initial distance between the sensor and a transceiver; accessing a maximum distance range between the sensor and the transceiver; determining that the maximum distance range between the sensor and the transceiver has been exceeded; generating an alert signal based on the determination that the maximum distance range between the sensor and the transceiver has been exceeded; and transmitting the alert signal to the transceiver.

Yet another embodiment is directed to the method described above, further comprising transmitting the alert signal to an emergency response device.

Yet another embodiment is directed to the method described above, further comprising transmitting the alert signal to a third party device.

Yet another embodiment is directed to the method described above, further comprising generating a geolocation identifier, based at least in part on a location of the sensor; and transmitting the geolocation identifier to the transceiver.

### BRIEF DESCRIPTION OF THE SEVERAL VIEWS OF THE DRAWINGS

The foregoing summary, as well as the following detailed description of the exemplary embodiments of the invention will be better understood when read in conjunction with the appended drawings. For the purpose of illustrating the invention, there are shown in the drawings exemplary embodiments. It should be understood, however, that the exemplary embodiments are not limited to the precise arrangements and instrumentalities shown.

In the drawings:

FIG. 1 illustrates an exemplary cargo alerting system in accordance with an exemplary embodiment of the subject disclosure;

FIG. 2 illustrates a block diagram of an exemplary keyfob of the cargo alerting system as described herein;

FIG. 3 illustrates an exemplary circuit diagram of the keyfob of the cargo alerting system as described herein;

FIG. 4 illustrates a block diagram of an exemplary base of the cargo alerting system as described herein;

FIG. 5 illustrates an exemplary circuit diagram of the base of the cargo alerting system as described herein;

FIG. 6 is an embodiment of an exemplary method for cargo alerting in accordance with an exemplary embodiment;

FIG. 7 shows a network environment of an alert system according to an exemplary embodiment of the disclosure;

FIG. 8 is an exemplary method for cargo alerting in accordance with an exemplary embodiment of the disclosure; and

FIG. 9 is another exemplary method for cargo alerting in accordance with another exemplary embodiment of the disclosure.

### DETAILED DESCRIPTION

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not necessarily drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

Tragic deaths by unattended children, pets, or other precious cargo will cease when drivers have available a self-arming alarm system that alerts an individual hurrying to work or another commitment.

The present cargo alerting system, sometimes referred to herein as “Forget Mee Not,” is self-arming: simply placing a child in a car seat or in a car equipped with

Forget Mee Not operates to arm the system. A keyfob, or smartphone, or other RF receiving/transmitting device, is carried by the user, such as a driver or passenger and sounds an alarm when the keyfob, or smartphone, is moved farther than a pre-determined distance from a base, which may be in the car seat, or otherwise connected to a child in the vehicle. This preset distance could be any desired distance. One example of a distance is about 10 feet between the keyfob and the sensor. The keyfob and alarm are operable to refocus the user's attention on the cargo within the vehicle.

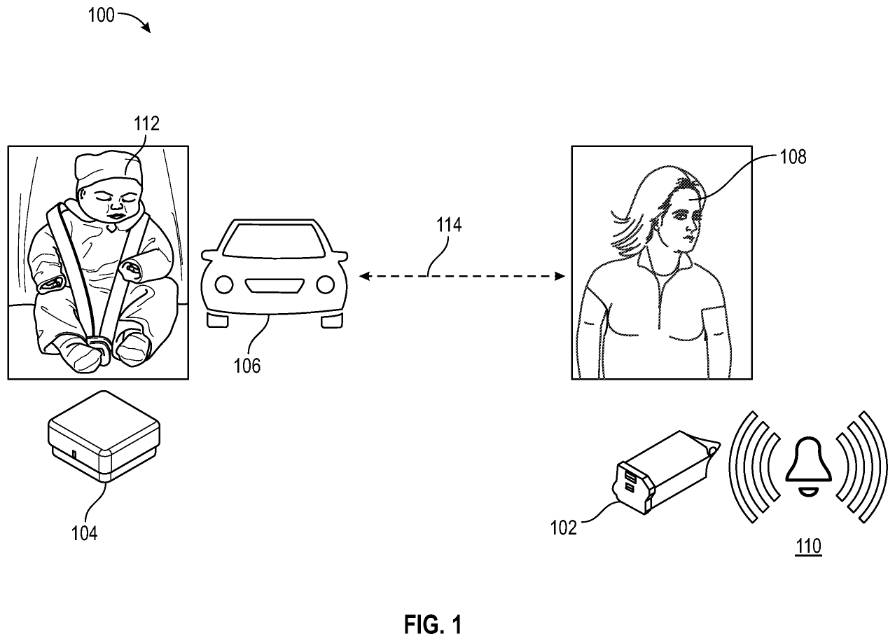

FIG. 1 illustrates an exemplary cargo alerting system 100 in accordance with an exemplary embodiment of the present invention. The cargo alerting system 100 includes a transceiver, such as a keyfob, or smart phone, 102 and a base 104 inside a vehicle 106. A child 112 is seated in the vehicle 106 with base 104 positioned relative to the child 112. A wireless communication path 114 provides a signal path from sensor 104 to transceiver 102. A person, or user, 108 has possession of the transceiver 102 such that the person 108 can sense, e.g., hear, visually observe, or feel an alert signal 110 emanating from transceiver 102.

The transceiver, such as a keyfob, or smartphone, 102 is carried by a driver or passenger 108 of the vehicle 106 and is in communication with the base 104, which is positioned inside the vehicle 106. Using a smartphone as the transceiver 102 has a benefit that an icon, or graphic can be displayed on the screen of the phone 102. This also permits an audible alarm condition to be output from the smartphone 102, using the speaker of the smartphone 102. A user can also use the smartphone 102 to receive location data transmitted by the base 104. The smartphone 102 can also be used to call emergency personnel, such as 911, when the base 104 is more than a predetermined distance from the smartphone 102.

The base 104 may be positioned in any suitable location inside vehicle 106. One common location is under the child 112. This may be accomplished by placing the base 104 under or in a car seat or infant carrier or in a location such that the weight of the infant can be sensed by the base 104.

The base 104 includes a cargo-detecting assembly that can be disposed, for example, on or in an after-market or third-party car seat placed in the vehicle 106, a rear or front seat in the vehicle, a stroller, or cargo space such as a rear or front trunk of the vehicle, as seen in FIG. 1. Alternatively, the cargo-detecting assembly can be integrated with the car seat, vehicle seat, cargo space, or stroller. The cargo-detecting assembly is configured to activate upon placement of the cargo 112 atop the base. The cargo-detecting assembly can include sensors, such as weight-sensitive sensors, which are configured for wireless communication with the keyfob, or smartphone, 102, for example using radio frequency (RF) encoders and transmitters.

The base 104 may have a transmitter and an antenna to generate and transmit a sensor signal to a desired location such as keyfob or smartphone 102 or other location or device, as described herein. The base is designed to transmit an RF signal to a desired location.

An alarm or other event 110 may be triggered by the keyfob, smartphone 102 and/or the base 104 upon detecting that the driver or passenger has travelled farther than a pre-determined distance from the device or the vehicle.

The keyfob 102 is adapted to be carried by the driver 108, as seen in FIG. 1. The keyfob is configured to trigger an event 110, such as sounding an alarm when the keyfob is farther than a pre-determined distance from the base 104, e.g., about 10 feet from the base. Advantageously, triggering such an event can refocus the driver's attention on the precious cargo 112 atop the base within the vehicle 106.

Transceiver, which may be a keyfob or a smartphone, 102 may generate an alert signal, or notification based at least in part on the sensor signal generated by the base 104. The sensor signal is transmitted from the base 104 to the transceiver 102 via wireless communication link 114. The alert signal may be a flashing or blinking light, sound and/or vibration so that an individual 108 will become aware of the child 112 is the vehicle 106. The smartphone 102 may also have an application, downloaded from a remote device, via a network, as described herein.

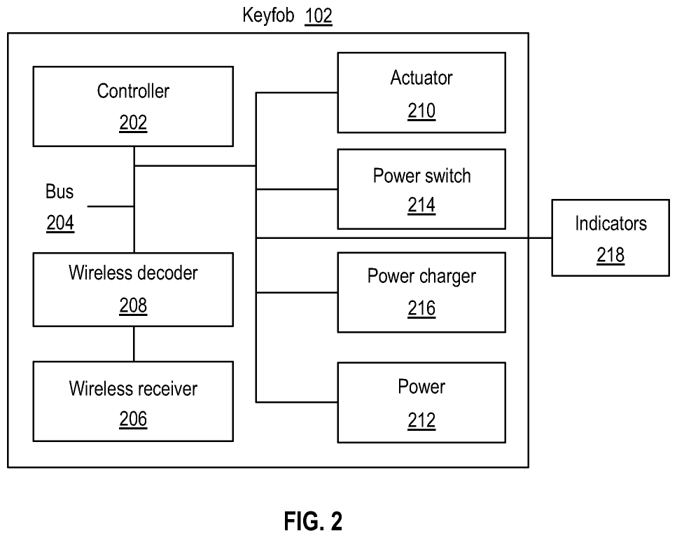

FIG. 2 illustrates a block diagram of an exemplary keyfob of the cargo alerting system as described herein. An exemplary block diagram is shown in FIG. 2 for the transceiver 102, which may be a keyfob, smartphone, or other RF transmitting or RF receiving device. Typically, the transceiver will have a graphical user interface (GUI) and be configured to download and utilize applications. The transceiver 102 includes a controller 202 in communication over a bus 204 with a wireless receiver 206 and a wireless decoder 208. The controller is also operatively in communication with an actuator 210. The transceiver 102 further includes a power source 212, a power switch 214, a power charger 216, and indicators 218.

The controller 202 is operatively in communication over the bus 204 with the wireless receiver 206 and the wireless decoder 208 for cargo alerting. The controller 202 can be a microcontroller, a programmable logic controller, a computer, and the like. The controller 202 is housed in a housing of the base (shown as element 104 herein). The controller 202 is configured to receive and decode a wireless signal, via the wireless receiver 206 and the wireless decoder 208, indicating the presence of the cargo on or in the base (shown as element 104 herein). The controller 202 is further configured to trigger an alert, via the actuator 210, upon receiving and decoding the signal indicating that the cargo sensors of the base (shown as element 104 herein) have detected a weight representing the cargo.

The wireless receiver 206 and the wireless decoder 208 are configured to receive and decode a wireless signal received from the base (shown as element 104 herein). The signal can indicate, for example, a presence of a weight such as the cargo on the base. The wireless receiver 206 is also configured to detect whether the transceiver 102 is within a pre-determined distance of the base, e.g., about 10 feet from the base. The wireless receiver 206 can be, for example, a radio frequency (RF) receiver and the wireless decoder 208 can be, for example, an RF decoder.

The actuator 210 is configured to trigger an alarm or other event to notify a person in possession of the transceiver 102 that the cargo may have been inadvertently left in the vehicle 106. The actuator 210 can be, for example, a vibration motor operatively connected to the controller 202.

The power source 212 may be activated by the power switch 214 and powered by the power charger 216. The power source 212 can be, for example, a lithium-ion battery, other battery, or other suitable power source that provides from about 1.5 to about 4.5 volts, such as a 4.2-volt lithium-ion battery. Accordingly, the power charger 216 can be a lithium-ion battery charger. The power charger 216 is configured to charge the power source 212, for example, via Universal Serial Bus (USB) charging. The power switch 214 can be an optional slide switch that allows the driver or passenger to power the transceiver 102 to an “on” state or “off” state, for example, so as to allow the power source 212 to charge.

The transceiver, or keyfob, or smartphone, or wireless remote controller, having an RFID and an antenna,102 also includes one or more indicators 218. The indicators 218 can provide a visual indication, such as an LED, flashing light, an audible indication, such as a tone, or beep or a vibrational indication, such as a buzz or other vibratory output. The indicators 218 can include status indicators such as power indicators. For example, the indicators 218 can be one or more light-emitting diode (LED) indicators. The indicators can indicate the power or charge status of the controller 102. For example, a yellow LED can indicate a notification that the charge or power level is somewhat low, and a red LED can indicate a warning that the charge or power level is below an operational threshold, such as 20 percent of a full charge and the power source should be recharged.

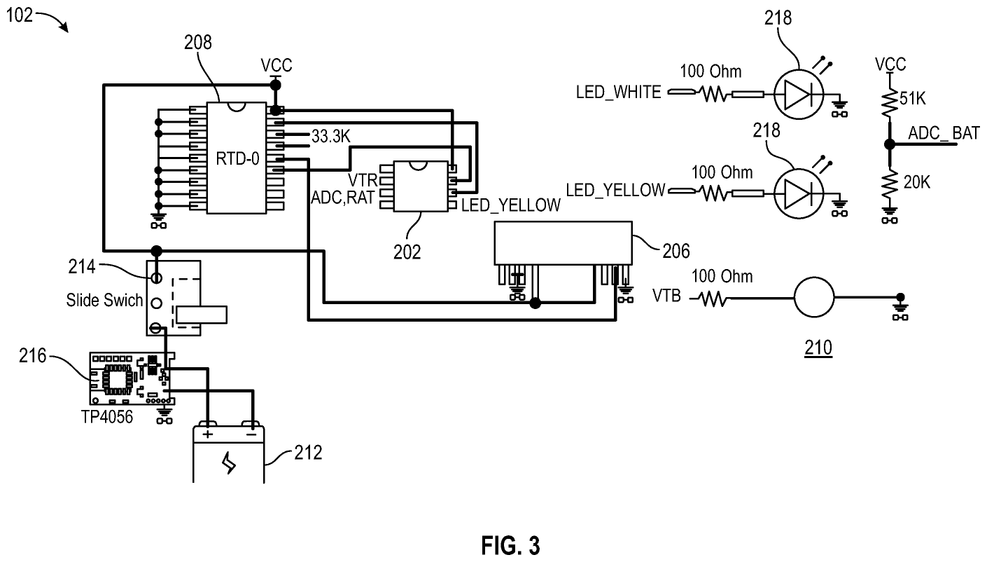

An exemplary circuit diagram is shown in FIG. 3 for the remote controller, or keyfob 102. The controller 202 of the remote controller 102, is operatively coupled to the wireless decoder 208. The wireless decoder is operatively coupled to the wireless receiver 206. The power source 212 is coupled to the power switch 214 and the power charger 216 and powers the actuator 210 and the indicators 218.

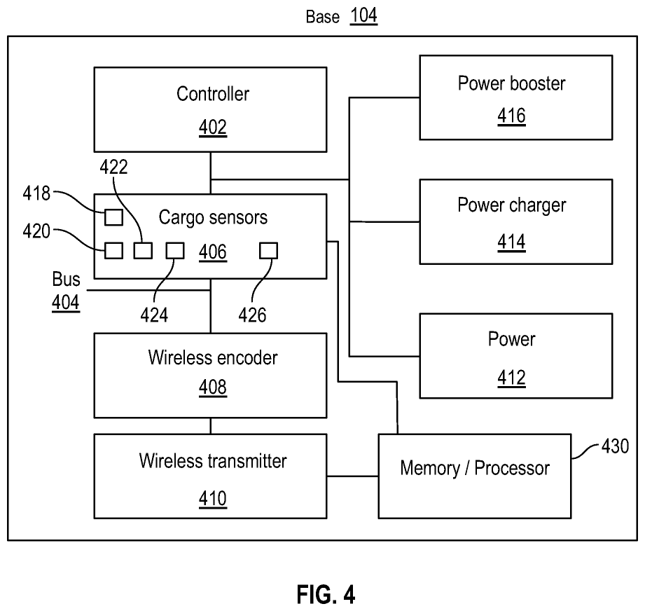

An exemplary block diagram is shown in FIG. 4 for the base 104. The base includes a base controller 402 operatively coupled to bi-directional communication bus 404 that provides a communication path with one or more cargo sensors 406. The cargo sensors have a weight sensor 418, a weight distribution sensor 420, a moisture sensor 422, a distance sensor 424 and geolocation sensor 426.

Memory and processor device 430 is operatively coupled to cargo sensors 406 and base controller 402. The memory and processor device 430 has adequate memory and processing power to generate alerts based on the cargo sensors 406 (including sensors 418, 420, 422, 424 and 426). The memory of memory and processor device 430 is non-transitory computer-readable electronic memory, such as EEPROM, ROM, or other suitable electronic storage medium.

The base controller 402 is also operatively in communication with a wireless encoder 408 and a wireless transmitter 410. The base further includes a power source 412, a power charger 414, and a power booster 416.

The base controller 402 is operatively in communication over the bus 404 with the cargo sensors 406, the wireless encoder 408, and the wireless transmitter 410 for cargo alerting. The base controller 402 can be a microcontroller, a programmable logic controller, a computer, and the like. The base controller 402 is housed in a housing of the base 104. The base controller 402 is configured to trigger an alert upon detecting, via the cargo sensors, that a cargo may have been inadvertently left atop the base, the cargo may have shifted, or the cargo may be wet, or have an increase in moisture. The cargo may be a child, product or other object.

The cargo sensors 406 are configured to detect that the cargo, such as a child, or other object, may have been inadvertently left in the vehicle. The cargo sensors 406 include weight sensor 418, weight distribution sensor 420, a moisture sensor 422, a distance sensor 424 and a geo-location sensor 426. The cargo sensors 406, including weight sensor 418, weight distribution sensor 420, moisture sensor 422, distance from keyfob, or smartphone, sensor 424, and geo-location sensor 426 can be operatively connected to the wireless encoder 408 or the base controller 402.

The weight sensor 418 senses a change in weight of an object place in a seat or otherwise in proximity to the base 104. The sensing of additional weight, such as placing an object on, or in proximity to the base 104, can arm, or initial the weight sensor 418.

A change in distribution of the weight sensed, may be sensed by weight distribution sensor 420. A change in weight distribution sensed by sensor 420 can result in a sensor signal being generated by cargo sensors 406. This weight distribution sensor 420 can be used to sense if a child has shifted position, such that a new position is not adequately centered on a seat or base member 104. This is useful in a situation in which a child has moved from the position of initial placement. This sensor prevents a child from slipping from a seat or moving or squirming into an unsafe position in a car seat, restraining seat or other support seat.

Alternatively, the cargo sensor for distribution of weight 420 can be a pressure-sensitive pad operatively connected to the wireless encoder 408 or the base controller 402 of base 104.

A sensed moisture by moisture sensor 422 can result in a sensor signal being generated by cargo sensors 406. The sensor 422 senses if a baby has a wet diaper, spilled drink, or is otherwise wet. This sensed signal facilitates a care giver making sure the baby is dry and comfortable.

Distance sensor 424 may be used to ensure that when a keyfob, transceiver, or other device is moved or positioned more than a predetermined, or preset distance, from the base 104, an alert signal is generated and transmitted so that a receiving device and/or location will receive the alert signal and generate or output a desired alarm and/or take remediating steps. The device could be a keyfob, transceiver, receiver, RF device with an antenna, or other suitable device that can receive a signal and out an alarm, either visual, audible, or vibratory. A location could be a third party cellphone, third party tablet, emergency responder dispatcher, or other desired reception device and/or location.

A distance, such as 100 yards, or other desired distance can be preset, or input by a user to the cargo sensor 406. This distance can be adjusted, modified or otherwise changes by a user.

Geo-location sensor 426 is used to sense a location, such as GPS coordinates to identify the location of the base 104. This geo-location sensor 426 provides location data of the base. For example, if a baby is in a baby stroller having a base disposed beneath the baby and the stroller is moved, the geo-location sensors can provide the exact current location of the base, and stroller to a receiver, such as a keyfob, smartphone, third-party cell phone and/or emergency personnel. Thus, the geo-location sensor provides a tracking technique to provide location information of a stroller having a base 104. The geo-locator sensor 426 can generate an alert signal if the base is moved from the initial location of the base.

The base 104 is configured to remain generally inactive until the cargo sensors 418, 420, 422, 424 and 426 detect a change in the parameters of an object placed on or in the base and/or a change in the sensed distance between the base and a keyfob or a change in location of the base 104. This change in distance beyond a preset, or predetermined distance can cause the base to generate an alert situation. This alert can be transmitted to a keyfob and/or other desired location.

Once there is a sensed condition the cargo sensor 406 sends a signal to the keyfob, transceiver or controller 102 and/or other desired location or device, such as a third party cell phone, third party tablet and/or emergency responder location. The controller 102 can output a signal indicative of the sensed condition.

The wireless encoder 408 and the wireless transmitter 410 are configured to encode and transmit a wireless signal indicating the presence and/or condition of the cargo, such as a child. The signal can indicate, for example, a presence of a weight on the base, such as a child being place or removed from the base 104, a change in position of the weight of the object, such as a child twisting or moving relative to the initial position of the child relative to sensor 104, or a change in moisture of the object, such as a child who is wet or a change in distance between the base and a receiver, keyfob, transceiver device. The wireless encoder 408 can be, for example, a radio frequency (RF) encoder, and the wireless transmitter 410 can be, for example, a RF transmitter.

The power source 412 is powered by the power charger 414. An optional power booster 416 can be configured to boost the power supplied by the power source 412. The power source 412 is, for example, a lithium-ion battery that provides from about 1.5 to about 4.5 volts, such as a 4.2-volt lithium-ion battery. Alternatively, the power source 412 could be solar panels, rectifiers, DC generators, and the like. Accordingly, the power charger 414 can be a lithium-ion battery charger. The power charger 414 is configured to charge the power source 412, for example, via Universal Serial Bus (USB) charging. The power booster 416 can be, for example, a switch mode DC-DC converter such as a boost converter configured to increase or boost the voltage of the battery, in the event that the battery provides insufficient voltage on its own.

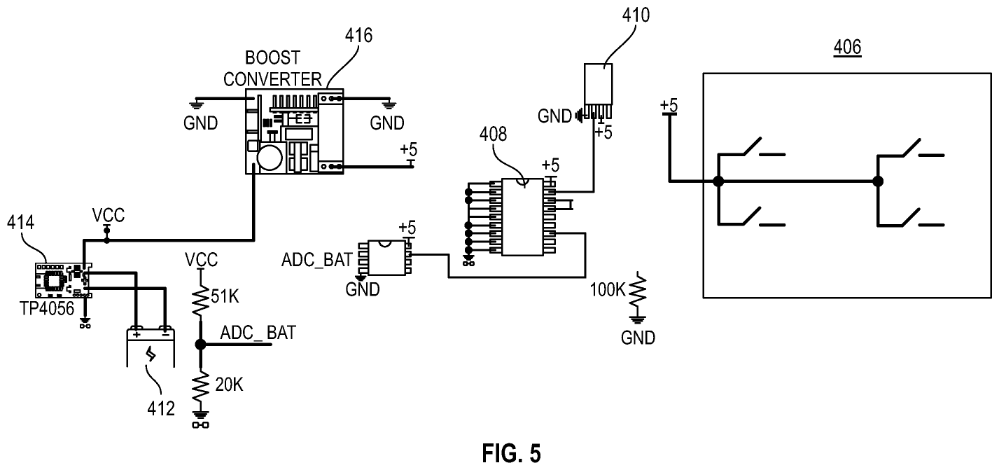

An exemplary circuit diagram is shown in FIG. 5 for the base 104. The base controller 402 is operatively coupled to the wireless encoder 408. The wireless encoder 408 is communicatively coupled to the cargo sensors 406 and operatively coupled to the wireless transmitter 410. The power source 412 is coupled to the power charger 414 and the power booster 416.

In operation, the base 104 including the cargo-detecting assembly 406 (418, 420, 422) is placed in or integrated into a car seat and remains inactive or off until a cargo, such as a child, is placed in the car seat. The weight of the cargo, for example, the child, activates the cargo-detecting assembly 406. The wireless encoder 408 communicatively coupled to the cargo-detecting assembly 406 encodes a signal for transmission. The wireless transmitter 410 begins transmission of the encoded signal to the keyfob, or transceiver 102, as shown herein, periodically, for example, every 15 seconds or every three minutes, or other suitable time interval. The time interval can be adjusted by the user of the transceiver 102 and can be based on the ambient temperature, day of the week or other criteria.

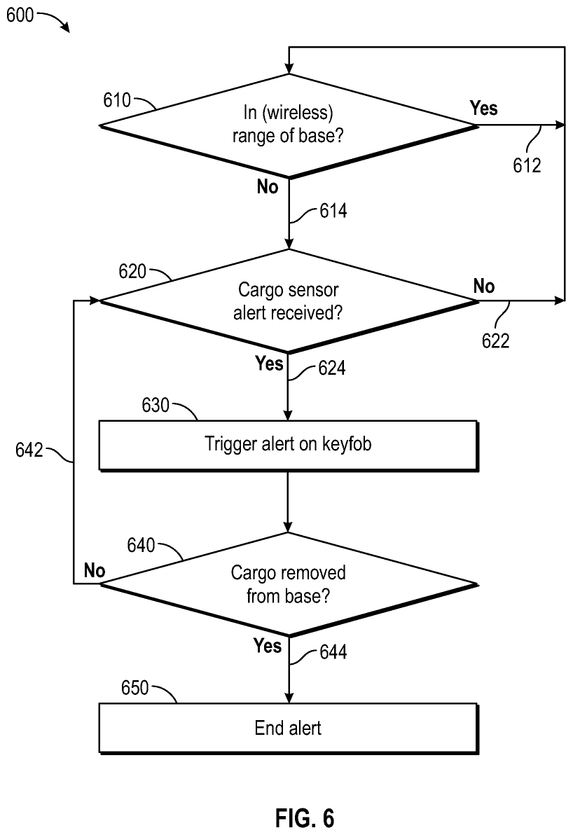

FIG. 6 illustrates a flowchart of an exemplary method 600 for cargo alerting. The keyfob, or smartphone, determines whether the base is within a predetermined range, 610. For example, the controller of the keyfob determines, via the wireless receiver, whether it continues to receive a wireless signal transmitted from the base. If so, “yes” 612 indicates that the wireless receiver continues to receive the wireless signal, and the controller determines that the keyfob remains within the pre-determined range of the base and the driver, or user, does not require alerting as to the cargo that may be in the vehicle. Accordingly, the controller returns to determining whether the base is in range, 610.

If the wireless receiver stops receiving the signal, “no” 614 shows that the controller determines that the driver or passenger carrying the keyfob has moved beyond the predetermined, or preset range of the base.

If the driver or passenger has travelled beyond the predetermined, or preset range, the controller determines whether a wireless signal has been received, via the wireless receiver, indicating the detection of the cargo on or in the base, 620. The wireless receiver is configured to receive the wireless signal that the wireless decoder is configured to decode.

If the wireless signal indicates there is no cargo in the vehicle, such as there is not a child in a car seat, “no” 622 shows that the process continues to monitor the distance between the base and the keyfob.

If the wireless signal indicates detection of the cargo, “yes” 624 shows that the controller triggers an alert, 630. For example, the controller activates the actuator to vibrate to remind the driver or passenger of the cargo on the base. Alternatively, the controller can be configured to activate the indicators, such as LEDs, visual indicators or an audible alarm signal, or otherwise notify the driver or passenger to remind the driver or passenger that there may be a child in the vehicle and the driver, or user is beyond a predetermined range.

The alert continues until the keyfob determines that the cargo has been removed from the base, 640. If not, “no” line 642 shows the cargo sensor alert determination is reached, 620. If the cargo, such as a child has been removed from the base, “yes” 644 shows that the alert ends, 650.

For example, once the base detects removal of the cargo, the base ceases transmission of the wireless signal, causing the keyfob to reset the cargo alerting system and end the alert, 650. Alternatively, the base can encode and transmit a separate wireless signal indicating detection of the removal of the cargo.

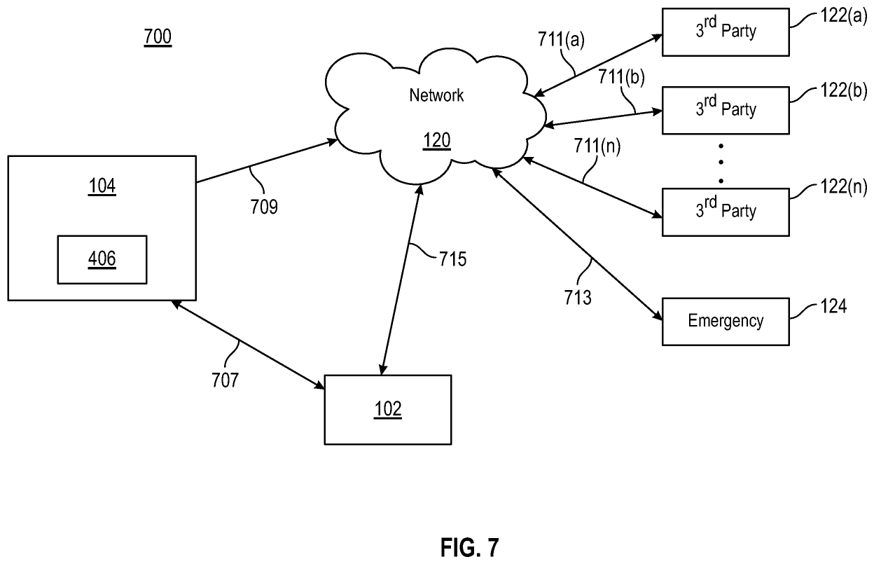

FIG. 7 shows a network environment 700 of an alert system according to an embodiment of the disclosure.

FIG. 7 shows a base 104, a network 120, keyfob 102, third party device(s) 122(a) . . . (n), where “n” is any suitable number, and emergency response location or device 124.

Base 104, which has been described herein may be a lower portion, or sensing portion of a child car seat, stroller, suspended baby seat, or other structure used to support a child, toddler and/or infant. The base has sensors 406 (base sensors 406 include any suitable number of sensors, such as weight sensor 418, distribution sensor 420, moisture sensor 422, and distance sensor 422, as shown herein).

Keyfob 102 has been described herein. The keyfob 102 may be a transceiver, or receiver, smartphone, or other radio frequency device having an antenna that is configured to output an indicator or alarm upon being positioned beyond a predetermined distance from the base 104 or receiving an alert signal from the base 104. The alert signal from the base may be a shift in the position of the cargo, or child, removal of the child from the seat, moisture increase of the child. The keyfob 102 may be in direct communication with the base 104 via wireless channel 707. Alternatively, the keyfob 102 may be in communication with the base 104 via network 120.

Cloud, or Internet, or network 120 is any suitable network of computers, processing devices, output devices, severs, or processors that provide bi-directional communication between base 104 and other devices, shown as keyfob 102, third party device 122(a) . . . (n), where “n” is any number and emergency response location, or device, such as a dispatcher, or other first responder 124. The network 120 is operatively coupled to base 104 via wireless communication channel 709. The network 120 is operatively coupled to keyfob 102 via wireless communication channel 715. The network 120 is operatively coupled to third party devices 122(a) . . . (n) via associated wireless communication channel 711(a) . . . (n), where channel 711 is bi-directional. The network 120 is operatively coupled to emergency location 124 via wireless communication channel 713, where channel 713 is bi-directional. The network 120 may include an electronic communication network, such as the Internet, a local area network (LAN), a wide area network (WAN), a cellular communications network, or the like.

The network 120 may include an Internet Protocol (IP) network via hypertext transfer protocol (HTTP), secure HTTP (HTTPS), and the like. The network 120 may also support an e-mail server configured to operate as an interface between clients and the network components over the IP network via an email protocol (e.g., Simple Mail Transfer Protocol (SMTP), Internet Message Access Protocol (IMAP), Post Office Protocol (POP), etc.).

Third party devices 122(a) . . . (n) may be smart phones, tablets or other suitable device that can receive data from base 104 via network 120, and/or receive signals directly from the base 102 via communication channel 707. Numbers associated with each third party device 122 may be preset, or preprogrammed into smartphone 102, such that upon generation of an alert, the numbers associated with third party devices 122 are automatically dialed. A desired sequence of third party devices can be established such that most preferred third parties are contact first.

The emergency location 124 may be a dispatcher, or other first responder location that responds to an alert signal generated by the base 104.

Those skilled in the art will appreciate that environment 700 is merely illustrative and is not intended to limit the scope of the embodiments described herein.

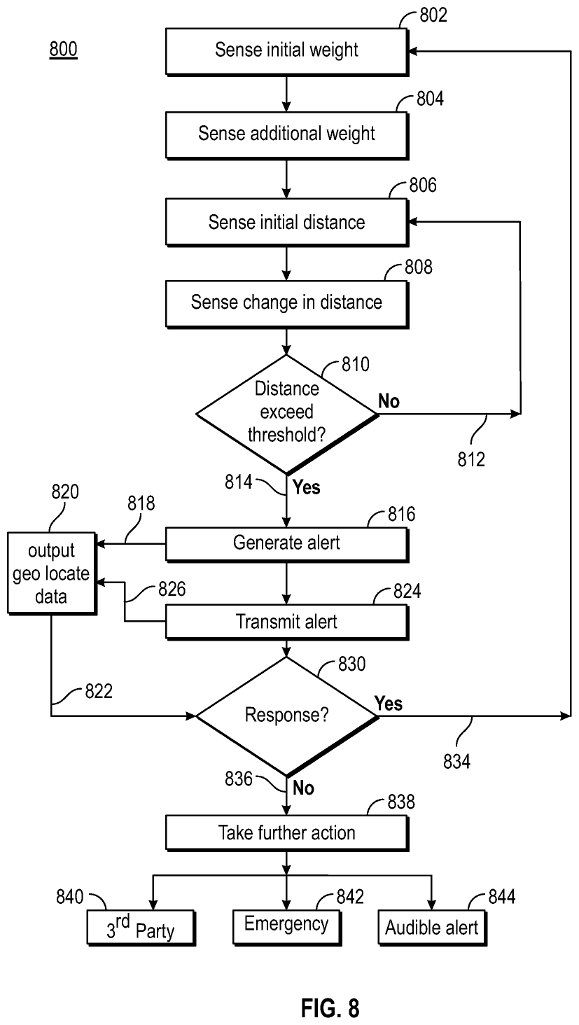

FIG. 8 is an embodiment of an exemplary 800 method for cargo alerting in accordance with an exemplary embodiment of the disclosure.

An initial weight is sensed by the base, 802. This initial weight may be a tare weight or weight of a car seat that is not occupied. The base then senses when additional weight, such as the weight of a child is place in the car seat, or otherwise registered by the base; specifically, the sensors of the base sense the change in weight 804.

The sensing of the additional weight 804 sets the base of the system so that sensors in the base monitor the position of the keyfob relative to the base.

The base senses an initial distance between the base and the keyfob, 806, which is less than the predetermined, or preset distance.

The distance between the base and the keyfob is sensed, 808. A determination is made whether the distance between the base and the keyfob exceeds a predetermined threshold. If the distance is less than the predetermined threshold, i.e., it does not exceed the threshold, “no” 812 shows the distance is sensed, 806.

If the distance does exceed a predetermined distance, “yes” 714 shows that an alert is generated, 816 and can include geolocation data, 818, 820.

The alert can be transmitted 824 to a desired location, such as a keyfob, third party and/or emergency personnel and can include geolocation data, 826 to 820.

A response can be received, 830. If so, “yes” 834 shows that an initial weight condition can be sensed 802.

If no response is received, “no” 836 shows that further action can be taken, 838. The further action can be notifying a third party, 840, and/or notifying emergency personnel, such as fire/police/ambulance, 842 and/or providing an audible alarm at the base, 844.

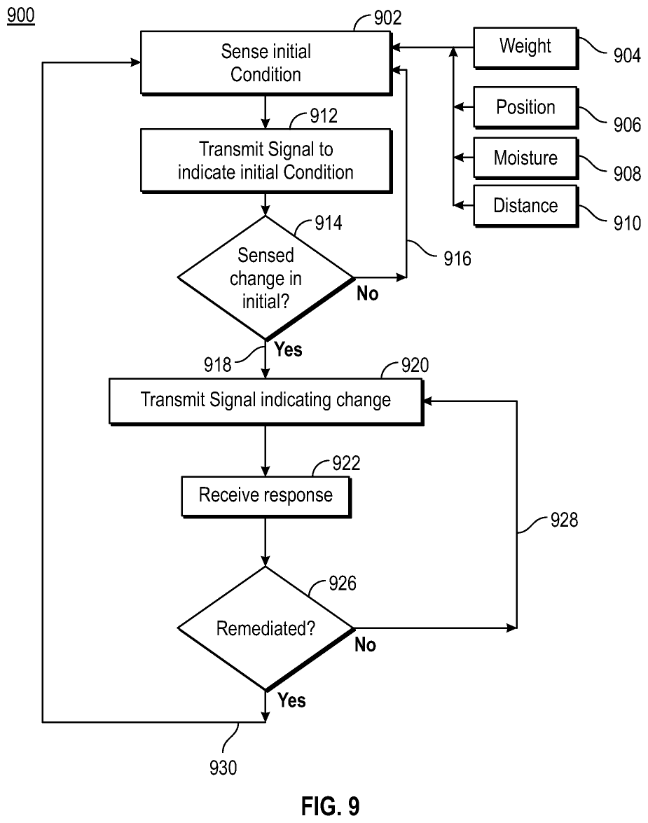

FIG. 9 shows another embodiment of an exemplary method 900 for cargo alerting in accordance with another exemplary embodiment of the disclosure. As shown in FIG. 9, an initial condition is sensed 902. The initial sensed condition can utilize a number of parameters, such as weight of the cargo, 904, sensed by the sensor, a position of the weight, 906, sensed by the sensor, a moisture level, 908 sensed by the sensor and a distance, 910 of the cargo from a keyfob, transceiver or other RF device.

This is sensed by a base, as shown herein as element 104 having sensors, shown herein as element 406. The predetermined maximum distance between the base and the keyfob can be input by a user and stored in a memory, as described herein.

A signal is transmitted from the base to a receiver, such as a keyfob, or other reception device, 912.

A determination is made, 914, whether there is a change in any of the parameters, weight, position, moisture, distance. If not, “no” 916 shows that the initial conditions are continued to be sensed, 902.

If there is a change in any parameter, “yes” 918 shows that a message is transmitted to a location and/or device, such as a keyfob, third party phone and/or emergency personnel, 920. This location, or reception device could be associated with one or more preset telephone numbers, such as a family friend, spouse or other trusted third-party. The contact number of the desired person could be automatically dialed from the smartphone of the user. The smartphone could also be programmed to call preset numbers in a desired sequence. Thus, a first choice for a friend or family member would be called first.

The base can receive an acknowledgement. A determination is made, 926, whether the situation that caused the alert has been remediated. If not, “no” 928 shows the signal indicating the change 920 is continually transmitted. If the condition has been remediated, “yes” 930 shows the conditions are sensed, 902.

It will be appreciated by those skilled in the art that changes could be made to the various aspects and exemplary embodiments described above without departing from the broad inventive concept thereof. It is to be understood, therefore, that the subject application is not limited to the particular aspects disclosed, but it is intended to cover modifications within the spirit and scope of the subject disclosure as defined by the appended claims.

I/we claim:

1. An alert system comprising:
a sensor configured to sense an initial weight, a second weight, and an initial distance of the sensor to a transceiver, and generate a sensor signal upon sensing a changed distance from the initial distance that exceeds a predetermined threshold when the second weight has been sensed; and
wherein the transceiver, operatively coupled to the sensor, is configured to receive the sensor signal from the sensor and generate an alert signal based at least in part on the sensor signal.

2. The alert system of claim 1, wherein the sensor is a moisture sensor.

3. The alert system of claim 1, wherein the sensor is configured to sense a shift in a weight distribution.

4. The alert system of claim 1, wherein the sensor is configured to transmit the sensor signal to emergency personnel.

5. The alert system of claim 1, wherein the sensor is configured to transmit the sensor signal to a third party.

6. The alert system of claim 1, wherein the transceiver is configured to output an audible alarm.

7. The alert system of claim 1, wherein the sensor is configured to output an audible alarm.

8. The alert system of claim 1, wherein the sensor signal includes location data of the sensor to one or more devices or locations.

9. A notification system comprising:
a support seat;
a sensor disposed in the support seat, the sensor configured to sense an increase in weight of the support seat, and an increase in a distance between the sensor and a transceiver, when there is an increase in weight, and generate a sensor signal when the increase in distance between the sensor and the transceiver exceeds a pre-determined distance; and
the transceiver, operatively coupled to the sensor, the transceiver configured to receive the sensor signal from the sensor, and generate a notification based at least in part on the sensor signal.

10. The system of claim 9, wherein the sensor is configured to generate an audible distress alarm based at least in part on the sensor signal.

11. The system of claim 9, wherein the transceiver is configured to transmit the notification to a remote device.

12. The system of claim 11, wherein the remote device is associated with preset mobile phone number.

13. The system of claim 9, wherein the sensor is configured to transmit location data of the sensor to the transceiver and the sensor is configured to transmit location data of the sensor to a remote device.

14. The system of claim 9, wherein the sensor is configured to sense a change in weight distribution and generate a sensor signal when a change in weight distribution is sensed.

15. The system of claim 9, wherein the sensor is configured to sense moisture on the support seat and generate an alarm based at least in part on the sensed moisture.

16. A method for providing an alert comprising:
identifying an initial weight;
identifying additional weight;
setting a sensor setting to reflect the additional weight;
sensing an initial distance between the sensor and a transceiver;
accessing a maximum distance range between the sensor and the transceiver;
determining that the maximum distance range between the sensor and the transceiver has been exceeded;
generating an alert signal based on the determination that the maximum distance range between the sensor and the transceiver has been exceeded; and
transmitting the alert signal to the transceiver.

17. The method of claim 16, further comprising transmitting the alert signal to a remote device.

18. The method of claim 16, further comprising transmitting the alert signal to a third party device.

19. The method of claim 16, further comprising generating a geolocation identifier, based at least in part on a location of the sensor, and transmitting the geolocation identifier to the transceiver.
